(19) United States
(12) Patent Application Publication
(10) Pub. No.: US 2004/0126027 A1
(43) Pub. Date: Jul. 1, 2004

(54) Apparatus for deciding and managing coding mode in image coding and method thereof

(75) Inventors: Eun-Kyoung Park, Seoul (KR); Jong-Gu Jeon, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/667,395

(22) Filed: Sep. 23, 2003

(30) Foreign Application Priority Data
Dec. 30, 2002 (KR) 2002-87149

(51) Int. Cl. G06K 9/36; G06K 9/46

(52) U.S. Cl. 382/239; 382/236

(57) ABSTRACT

An apparatus and a method decide and manage a coding mode for each motion estimated block without an operation of a system control unit in an image coding and without storing a detected SAD for each motion estimated block. The apparatus includes a motion estimation unit, a system control unit, and a comparator. The motion estimation unit detects an optimal sum of absolute differences (SAD) by a motion estimated block when a motion is estimated by using a current frame data and a previous frame data. The system control unit outputs a predetermined threshold related to the optimal sum of absolute differences. The comparator compares the optimal sum of absolute differences output from the motion estimation unit with the predetermined threshold and outputs information indicating the coding mode for a current motion estimated block. The information indicating the coding mode output from the comparator is expressed by using a bit. Thus, it is possible to effectively manage a capacity of a memory and an operation of the system control unit when the motion is estimated.

### CROSS REFERENCES TO RELATED APPLICATIONS

This application claims the priority of Korean Patent Application No. 10-2002-0087149, filed on Dec. 30, 2002, in the Korean Intellectual Property Office, the disclosure of which is incorporated herein in its entirety by reference.

### BACKGROUND OF THE INVENTION

1. Field of the Invention

The present invention relates to an apparatus for deciding and managing a coding mode in an image coding and method thereof, and more particularly, to an apparatus for deciding a coding mode by a motion estimated block using a sum of absolute differences (SAD) detected by estimating a motion and managing information on the decided coding mode and a method thereof.

2. Description of the Related Art

A motion between a previous frame and a current frame is estimated, so that compressibility can be improved in an image coding. In motion estimation, an optimal sum of absolute differences (SAD) is detected by comparing a current frame data with a previous frame data by a motion estimated block. The SAD is calculated by accumulating each absolute value of a difference between a pixel of the current frame data and a pixel of the previous frame data by each current motion estimated block. Thus, when the motion is estimated, the number of SADs is equal to the number of blocks in the previous frame that is compared to a current motion estimated block. The optimal SAD is a smallest SAD among a plurality of SADs detected for the current motion estimated block.

According to the prior art, the optimal SAD detected in the image coding is stored in a memory. The SAD stored in the memory is defined by bits capable of expressing any SAD possibly detected. In the prior art, the apparatus for coding an image operates by defining the SAD using 16 bits. In addition, the SAD stored in the memory is updated by a frame. Thus, if a frame is processed by being divided into 32 motion estimated blocks, the number of SADs stored in the memory is 32.

The SAD is used to decide a coding mode of the motion estimated block, e.g., an intra coding or an inter coding. That is, a system control unit reads the SAD stored in the memory, compares the SAD with a predetermined threshold value, and decides the coding mode of the motion estimated block, e.g., the intra coding or the inter coding.

However, as a size of an image, which can be processed, has been gradually increased and a size of the motion estimated block is decreased, the number of SADs detected for each frame has increased. Thus, a capacity of the memory storing the SAD has to be increased. Also, since the number of comparison between the SAD and the threshold value increases, a quantity of operations of the system control unit for deciding the coding mode increases. As a result, if the size of the image to be processed becomes bigger and a unit for the motion estimation becomes smaller, operating efficiencies of the memory and the system control unit are degraded.

### SUMMARY OF THE INVENTION

The present invention provides an apparatus for deciding and managing a coding mode which makes it possible to effectively operate a memory and a system control unit in an image coding, and a method thereof.

The present invention also provides an apparatus for deciding and managing a coding mode by a motion estimated block, without a need for an operation of a system control unit in an image coding, and a method thereof.

The present invention also provides an apparatus for deciding and managing a coding mode by a motion estimated block without storing a sum of absolute differences (SAD) detected by a motion estimated block.

The present invention also provides an apparatus for managing a coding mode by minimizing a capacity of a memory, and a method thereof.

According to an exemplary aspect of the present invention, there is provided an apparatus for deciding a coding mode in an image coding. The apparatus comprises a motion estimation unit, a system control unit, and a comparator. The motion estimation unit detects an optimal sum of absolute differences (SAD) by a motion estimated block when a motion is estimated by using a current frame data and a previous frame data. The system control unit outputs a predetermined threshold related to the optimal sum of absolute differences. The comparator compares the optimal sum of absolute differences output from the motion estimation unit with the predetermined threshold and outputs information indicating the coding mode for a current motion estimated block. The information indicating the coding mode for the current motion estimated block is expressed by using a bit.

According to another exemplary aspect of the present invention, there is provided an apparatus for deciding and managing a coding mode in an image coding. The apparatus comprises a motion estimation unit, a comparator, a memory, and a system control unit. The motion estimation unit detects an optimal sum of absolute differences (SAD) for each motion estimated block when a motion is estimated by using a current frame data and a previous frame data. The comparator compares the optimal sum of absolute differences output from the motion estimation unit with a predetermined threshold and outputs information indicating the coding mode for a current motion estimated block. The memory stores the information indicating the coding mode for a current motion estimated block output from the comparator. The system control unit provides the comparator with the predetermined threshold and controls a coding operation for the motion estimated block with reference to the information indicating the coding mode stored in the memory.

Preferably, but not necessarily, the information indicating the coding mode is expressed by a bit which can be read by a frame by the system control unit. Preferably, but not necessarily, a bit of the information indicating the coding mode stored in the memory is assigned to each motion estimated block. Preferably, but not necessarily, the information indicating the coding mode is data for deciding whether the coding mode of the motion estimated block is an intra coding mode or an inter coding mode.

According to yet another exemplary aspect of the present invention, there is provided an apparatus for deciding and managing a coding mode in an image coding. The apparatus comprises a motion estimation unit, a comparator, and a memory. The motion estimation unit detects an optimal sum of absolute differences (SAD) for each motion estimated block when a motion is estimated by using a current frame data and a previous frame data. The comparator compares the optimal sum of absolute differences output from the motion estimation unit with a predetermined threshold and outputs information indicating the coding mode for a current motion estimated block. The memory stores the information indicating the coding mode output from the comparator. The predetermined threshold is set when a motion estimation is initialized and is updated by a frame by the system control unit under variable circumstances such as a case when a bit rate of an image is changed.

According to yet another exemplary aspect of the present invention, there is provided a method of deciding and managing a coding mode in an image coding. The method comprises detecting an optimal sum of absolute differences (SAD) for each motion estimated block when a motion is estimated by using a current frame data and a previous frame data and storing a comparison result of the optimal sum of absolute differences and a predetermined threshold as coding mode information for a current motion estimated block.

Preferably, but not necessarily, the method further comprises coding the motion estimated block with reference to the coding mode information. Preferably, but not necessarily, the coding mode information is used to decide an intra coding mode or an inter coding mode when a coding of the motion estimated block is performed.

### BRIEF DESCRIPTION OF THE DRAWINGS

The above and other illustrative aspects and advantages of the present invention will become more apparent by describing in detail exemplary embodiments thereof with reference to the attached drawings in which:

FIG. 1 is a functional block diagram of an apparatus for deciding and managing a coding mode in an image coding;

FIG. 2 shows an example of a storing format of information on a coding mode decided according to the present invention; and

FIG. 3 is a flowchart of a method of deciding and managing a coding mode in an image coding according to the present invention.

### DETAILED DESCRIPTION OF THE INVENTION

The present invention will now be described more fully with reference to the accompanying drawings, in which illustrative, non-limiting embodiments of the invention are shown.

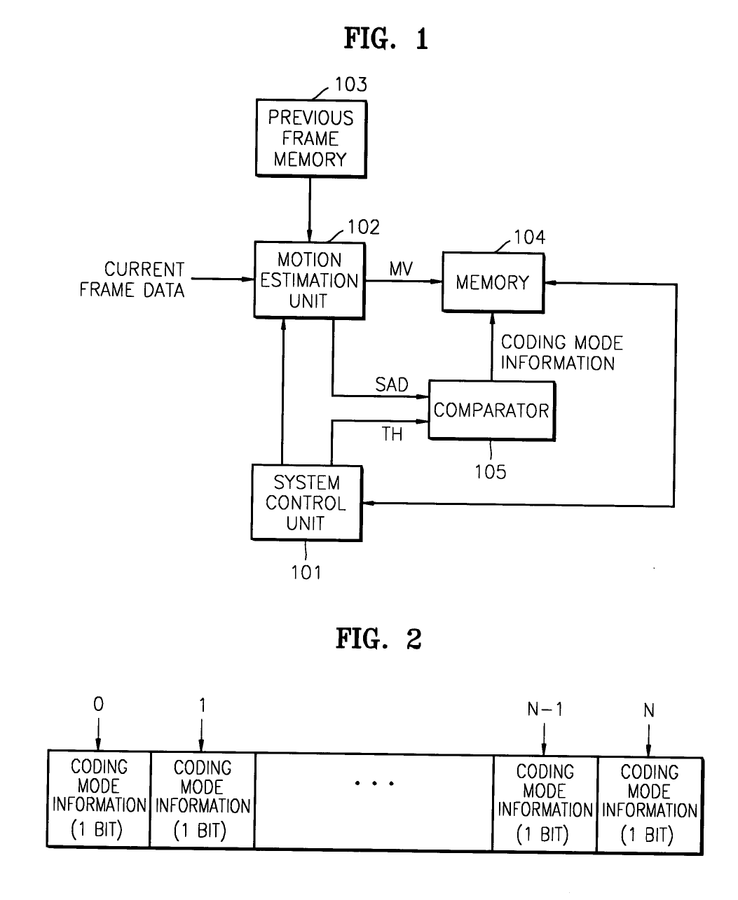

FIG. 1 is a functional block diagram of an apparatus for deciding and managing a coding mode in an image coding. Referring to FIG. 1, the apparatus according to the present invention includes a system control unit 101, a motion estimation unit 102, a previous frame memory 103, a memory 104, and a comparator 105.

The system control unit 101 provides the motion estimation unit 102 with a command to start estimating a motion and provides the comparator 105 with a predetermined threshold TH on estimating a motion. The predetermined threshold TH is used to determine a coding mode of a block based on a sum of absolute differences (SAD) detected by a motion estimated block. The predetermined threshold TH can be set when motion estimation is initialized and can be updated by a frame by the system control unit 101 under variable circumstances such as a case when a bit rate of an image is changed. The coding mode can be classified into an intra coding mode and an inter coding mode.

Upon receiving the command to start estimating a motion from the system control unit 101, the motion estimation unit 102 estimates a motion of current frame data using a previous frame data that is stored in the previous frame memory 103 by a predetermined motion estimated block. The motion may be estimated by adopting conventional coding methods such as MPEG (ISO), H.263 (ITU-T), or the like. The motion estimation unit 102 detects a motion vector MV and an optimal SAD by a motion estimated block. The optimal SAD is the smallest SAD among SADs detected by a predetermined motion estimated block. Then, the detected motion vector MV is transmitted to the memory 104 and the optimal SAD is transmitted to the comparator 105. The current frame data is currently inputted data. In order to provide the motion estimation unit with the current frame data, the apparatus according to the present invention may further comprise a memory (not shown) used to store the current frame data. The previous frame data is recovered frame data obtained by dequantizing quantized data.

The comparator 105 compares the optimal SAD with the predetermined threshold TH transmitted from the system control unit 101 and decides a coding mode for a current motion estimated block. That is, if the comparison of the comparator 105 indicates that the optimal SAD is greater than the predetermined threshold TH, information indicating that the coding mode for the current motion estimated block is an intra coding mode is output. If the comparison of the comparator 105 indicates that the optimal SAD is not greater than the predetermined threshold TH, information indicating that the coding mode for the current motion estimated block is an inter coding mode is output. If information on the intra coding mode is 1, information on the inter coding mode is 0. The information on the coding mode is an intra/inter coding identification bit for each motion estimated block.

The memory 104 stores the motion vector MV and the information on the coding mode received from the motion estimation unit 102 and the comparator 105, respectively, for each motion estimated block. The information on the coding mode stored in the memory 104 is stored in a unit of bits as shown in FIG. 2. FIG. 2 shows an example of a storing format of the information on the coding mode decided according to the present invention. The information on the coding mode of FIG. 2 is the intra/inter coding identification bit, and a bit of the information is assigned to each motion estimated block. Thus, FIG. 2 shows an example of storing the coding mode information for N+1 motion estimated blocks.

The system control unit 101 controls a coding process for the motion estimated block with reference to the coding mode information stored in the memory 104. Here, the system control unit 101 may refer to the coding mode information stored in the memory 104 for each motion estimated block or for each frame. Thus, if the N+1 bits of coding mode information of FIG. 2 is the coding mode information for one frame, the system control unit 101 can control the coding mode of the motion estimated block by reading all of the coding mode information, which is formed from bit 0 to bit N and is stored in the memory 104, at once.

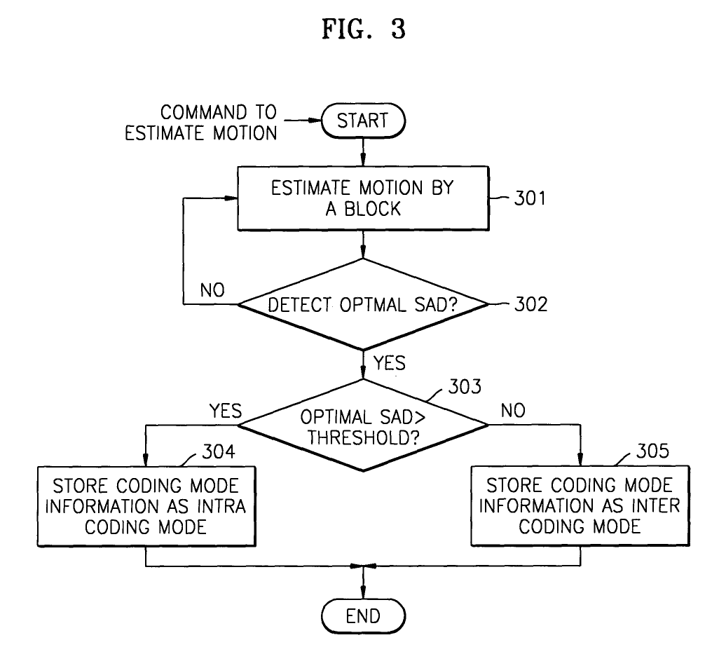

FIG. 3 is a flowchart of a method of deciding and managing a coding mode in an image coding according to the present invention.

If motion estimation is required, a motion of current frame data is estimated by a predetermined block with reference to previous frame data in step 301. As a result of the estimation in step 301, if it is determined that an optimal SAD for a motion estimated block has not yet been detected, a process goes back to step 301, and motion estimation for the motion estimated block is continued. The optimal SAD is the smallest SAD among a plurality of SADs detected by a motion estimated block.

If it is determined that the optimal SAD for the motion estimated block is detected in step 302, the detected optimal SAD is compared to a threshold in step 303. The threshold is equal to the predetermined threshold from the system control unit 101 of FIG. 1. If it is determined that the optimal SAD is greater than the threshold in step 303, information indicating that the coding mode for the motion estimated block is decided as an intra coding mode is stored in step 304. Here, the stored coding mode information is expressed by using a bit.

If the optimal SAD is not greater than the threshold in step 303, information indicating that a coding mode for the motion estimated block is decided as an inter coding mode is stored in step 305. Here, the stored coding mode information is expressed by using a bit.

As described above, the coding mode information expressed by using a bit stored for each motion estimated block is referred to when a coding operation is performed. The coding mode information may be referred to for each motion estimated block or for each frame.

According to the present invention, even though a size of an inputted image increased or a size of the motion estimated block is increased, it is possible to minimize a capacity of a memory used in relation with the coding mode by storing and using a comparison result between a detected SAD and a predetermined threshold as coding mode information, instead of storing the detected optimal SAD for each motion estimated block when the coding mode is decided for each motion estimated block.

In addition, by expressing the coding mode information by using a bit, an efficiency of a bus used to transmit the coding mode information can be improved. Since an operation of deciding a coding mode for each motion estimated block, processed by a system control unit is not required, it is possible to prevent an operating efficiency of the system control unit from degrading even when the size of the inputted image is increased or the size of the motion estimated block is decreased.

While the present invention has been particularly shown and described with reference to exemplary embodiments thereof, it will be understood by those of ordinary skill in the art that various changes in form and details may be made therein without departing from the spirit and scope of the present invention as defined by the following claims and their equivalents.

What is claimed is:

1. An apparatus for deciding a coding mode in an image coding, the apparatus comprising:
a motion estimation unit which detects an optimal sum of absolute differences (SAD) for a current motion estimated block when a motion is estimated by using a current frame data and a previous frame data;
a system control unit which outputs a predetermined threshold related to the optimal sum of absolute differences; and
a comparator which compares the optimal sum of absolute differences output from the motion estimation unit with the predetermined threshold output from the system control unit and outputs information indicating the coding mode for the current motion estimated block.

2. The apparatus of claim 1, wherein the information indicating the coding mode for the current motion estimated block is expressed by using a bit.

3. An apparatus for deciding and managing a coding mode in an image coding, the apparatus comprising:
a motion estimation unit which detects an optimal sum of absolute differences (SAD) for each of a plurality of motion estimated blocks when a motion is estimated by using a current frame data and a previous frame data;
a comparator which compares the optimal sum of absolute differences output from the motion estimation unit with a predetermined threshold and outputs information indicating the coding mode for a current motion estimated block;
a memory which stores the information indicating the coding mode for the current motion estimated block output from the comparator; and
a system control unit which provides the comparator with the predetermined threshold and controls a coding operation for the current motion estimated block with reference to the information indicating the coding mode stored in the memory.

4. The apparatus of claim 3, wherein the information indicating the coding mode for the motion estimated blocks is expressed by bits which can be read for a frame by the system control unit.

5. The apparatus of claim 3, wherein one bit of the information indicating the coding mode stored in the memory is assigned to each motion estimated block.

6. The apparatus of claim 3, wherein the information indicating the coding mode determines whether the coding mode of each motion estimated block is an intra coding mode or an inter coding mode.

7. An apparatus for deciding and managing a coding mode in an image coding, the apparatus comprising:
a motion estimation unit which detects an optimal sum of absolute differences (SAD) for each of a plurality of motion estimated blocks when a motion is estimated by using a current frame data and a previous frame data;
a comparator which compares the optimal sum of absolute differences output from the motion estimation unit with a predetermined threshold and outputs information indicating the coding mode for a current motion estimated block; and
a memory which stores the information indicating the coding mode output from the comparator.

8. The apparatus of claim 7, wherein the predetermined threshold is set when a motion estimation is initialized.

9. The apparatus of claim 8, wherein the predetermined threshold is updated by a frame by the system control unit.

10. The apparatus of claim 8, wherein the predetermined threshold is updated by the system control unit when a bit rate of an image is changed.

11. A method of deciding and managing a coding mode in an image coding, the method comprising:
detecting an optimal sum of absolute differences (SAD) for each of a plurality of motion estimated blocks when a motion is estimated by using a current frame data and a previous frame data; and
storing a comparison result of the optimal sum of absolute differences and a predetermined threshold as coding mode information for a current motion estimated block.

12. The method of claim 11, wherein the method further comprises coding the current motion estimated block with reference to the coding mode information.

13. The method of claim 11, wherein the coding mode information is used to decide an intra coding mode or an inter coding mode when a coding of the current motion estimated block is performed.

14. The method of claim 11, wherein the coding mode information is expressed by using a bit.

15. The method of claim 12, wherein the coding mode information stored is used to decide an intra coding mode or an inter coding mode when a coding of the current motion estimated block is performed.

16. The method of claim 12, wherein the coding mode information is expressed by using a bit.

17. The method of claim 12, wherein the current motion estimated block is coded with reference to the coding mode information read for a current frame.
